(19) United States
(12) Patent Application Publication
(10) Pub. No.: US 2006/0054287 A1
(43) Pub. Date: Mar. 16, 2006

(54) Flexible track screen system

(76) Inventor: Reynolds H. Dickinson III, Sycamore, IL (US)

Correspondence Address: Burkhart & Burkhart;Patent Attorneys, 940 Dakota Avenue, Whitefish, MT, 59937, US

(21) Appl. No.: 10/938,264

(22) Filed: Sep. 11, 2004

(51) Int. Cl. E06B 9/17

(52) U.S. Cl. 160/271

(57) ABSTRACT

A screen retention assembly for rolling screen systems covering an opening in a structure includes a retraction mechanism and a pull bar. A screen is secured to the retraction mechanism and the pull bar. At least one turning track spans the opening, and at least one flexible retention element is secured in the at least one track and attached to the pull bar and the retraction mechanism.

### CROSS-REFERENCE TO RELATED APPLICATIONS

This application is related to copending U.S. Application No. ______, Attorney Docket No. P0406, filed 28 Jun. 2004, “Constant Viscosity Speed Reducer”, invented by Reynolds H. Dickinson Ill.

### STATEMENT AS TO RIGHTS TO INVENTIONS MADE UNDER FEDERALLY-SPONSORED RESEARCH AND DEVELOPMENT

None

### FIELD OF THE INVENTION

The invention relates generally to rolling screen systems, specifically to arrangements for securing screens in such systems.

### DESCRIPTION OF RELATED ART

Rolling screen mechanisms have become increasingly popular in recent years. Rolling screens provide all of the advantages of traditional hinged screen doors, while affording additional benefits of appearance and convenience. Further, rolling screens can be installed in certain applications, such as french doors, where traditional screens cannot be used.

U.S. Pat. No. 6,701,994 to Goldenberg is directed to sliding screen frame for a closure assembly, the frame comprising framing sections assembled to form the screen frame, one of the frame sections being adapted to contain a roll out screen, the roll out screen being slidable between a fully extended position, whereat the screen is substantially payed out from the roll, and a fully retracted position; wherein the screen frame is free to slide in the closure assembly whether the roll screen is at the fully extended or the fully retracted position.

In another example, U.S. Pat. No. 6,463,983 to Lang deals with a retracting screen with its mounting and guiding apparatus for a door or window opening. The apparatus includes a housing from which and into which a screen is rolled, a drawbar for withdrawing the screen from the housing and for latching the screen in a closed position, and tracks for guidance of the drawbar across an opening. The housing is aesthetically mounted within a framed opening. The guidance system for the drawbar is adapted to accommodate slight structural variances in an opening by the cooperation between the drawbar structure and the elements of the track.

U.S. Pat. No. 6,591,890 to Grubb shows a retractable screen mechanism having two tracks mounted on opposing sides of an opening and a screen with a screen material mounted on a frame having two flexible opposing sides corresponding to and adapted to engage the two tracks. A spool mechanism for winding up the screen extends between the flexible opposing sides and engages a third side of the frame and is biased to a wind up position. The spool mechanism has a speed reducer which comprises a resistance structure moving through a viscous fluid to reduce the speed of the biased screen when moving to the wind up position.

In U.S. Pat. No. 6,082,432 to Kissinger, a roll-up screen door appliance for drawing a screen panel horizontally across the span of a door frame may be stably positioned in a partly open position for permitting persons to pass through with a minimum opening, thereby reducing the opening size for entry of insects. The screen panel is rolled up on a spring-biassed, vertically-oriented supply roller and is withdrawn by a manually moved pull rod clamped to the distal end of the screen panel. The pull rod is frictionally held in a stable position across the span of the accompanying door frame as it is withdrawn and the friction is overcome manually as the screen is retracted upon the storage roller by a spring biassed mechanism. A hollow rubber tubing, resting on both sides of a U-shaped channel across the span of the door provides a frictional clamp against end structure upon the pull rod which resides in both top and bottom channel members as it travels across the span of the door and tautly stretches the screen panel in position adjacent the corresponding door framework. The screen is protected against intrusion of insects by means of opposing brushes contacting upper and lower screen panel edges across the width of the door span as the screen panel is withdrawn from the roller. A light weight rectangular framework, enclosing a vertically oriented supply roller at one side, can be made of interconnected aluminum structural members to be fastened to a door frame about single or double pivoted mounted doors or sliding door pairs.

In another example, U.S. Pat. No. 5,794,678 to Beringer is directed to a roller door sealing system including at least one sealing member carried on the curtain, and disposed adjacent the end of the curtain attached to the roller, and a seal engaging member supported adjacent the curtain. The sealing member and the seal engaging member are disposed such that the sealing member engages the seal engaging member and seals the space between the curtain and the seal engaging member as the curtain approaches the doorway-blocking position. The sealing function provided by the sealing member or members only occurs as the door approaches the door blocking position.

In U.S. Pat. No. 5,392,835 to Wildt, a roll-type screen assembly is provided with lateral guide rails adjacent the sides of an opening with a window or door. The guide rails guide the lateral edges of the screen and contain an inflatable tube along the length thereof. A small hand pump with a release valve is employed to releasably lock the edges of the screen.

Although all existing mechanisms secure the screen in one fashion or another, known rolling screen systems are notorious for failing to stay in place under typical stress conditions. A sudden gust of wind or a misdirected push form a child or household pet can dislodge a closed rolling screen from its normal position, leaving gaps through which insects and other pests can enter. Further, the sealing mechanisms of some known screen systems are relatively complex, rendering them expensive to manufacture, install, and maintain.

It can be seen from the foregoing that the need exists for a retaining mechanism for rolling screen systems that overcomes the shortfalls of known arrangements in this technology.

### SUMMARY

In accordance with the principles of the present invention, a screen retention assembly for rolling screen systems covering an opening in a structure includes a retraction mechanism and a pull bar. A screen is secured to the retraction mechanism and the pull bar. At least one turning track spans the opening, and at least one flexible retention element is secured in the at least one track and attached to the pull bar and the retraction mechanism.

The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 illustrates a schematic view of a screen system in accordance with the principles of the present invention.

FIG. 2 illustrates a known turning track and pull bar cap.

FIG. 4 illustrates a known end cap.

FIG. 4 illustrates a flexible track, turning track, and pull bar cap in accordance with the principles of the present invention.

FIG. 5 illustrates an end cap in accordance with the principles of the present invention.

### DETAILED DESCRIPTION OF PREFERRED EMBODIMENTS

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

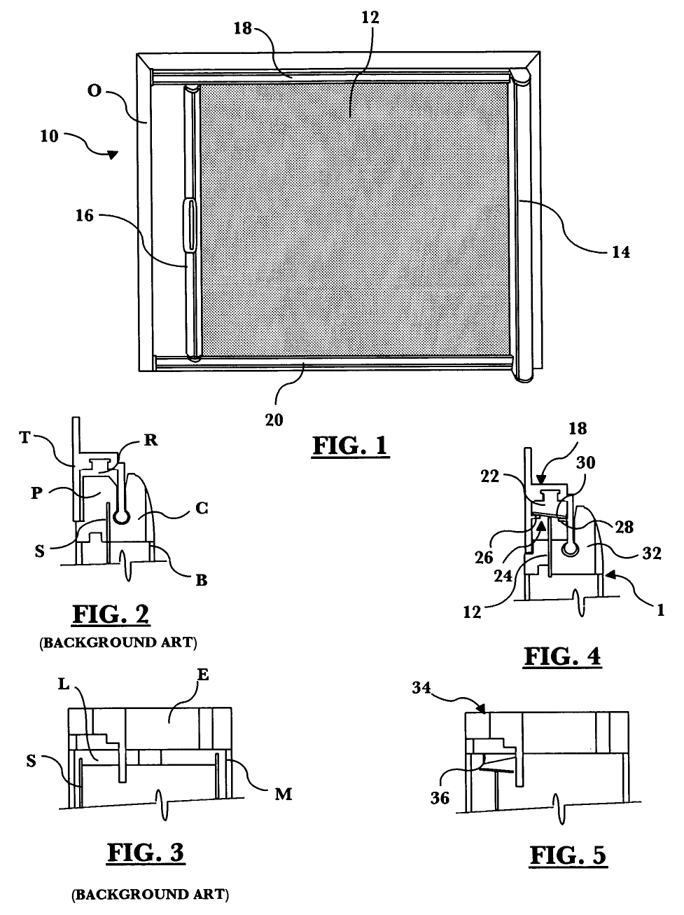

FIG. 1. illustrates a screen system 10 in accordance with the principles of the present invention. The screen system 10 is adapted to cover an opening 0 in a structure, such as an entry having french doors or similar closures. The screen system 10 includes a screen 12 secured to a retraction mechanism 14 and a pull bar 16. As the screen 12 is extended and retracted, it is guided within rail guides provided as a pair of turning tracks 18, 20 spanning the opening 0.

Conventional screen systems include tracks, one example of which is illustrated in FIG. 2. In conventional systems, a track T includes a longitudinal recess R. FIG. 3 illustrates another part of a conventional screen system structure, in which a pull bar B is provided with a sliding cap C, which in turn has a sliding piece P received in the cap C. A screen S is secured to the pull bar B, which opens or closes as the pull bar B is caused to slide along the track T. At an opposite end of the track T, a retraction mechanism M is provided with an end cap E (FIG. 3). As the screen is retracted by the mechanism M, it passes through a slot L in the end cap C.

As shown in FIG. 4, the screen system 10 of the present invention, the track 18 includes a recess 22 having a support arrangement 24. In the illustrated embodiment, the support arrangement 24 is provided as a pair of longitudinal ledges 26, 28 extending along opposed interior surfaces of the recess 22. A retention element 30 is connected to the screen 12. The retention element 30 is provided as a durable, flexible strip fabricated from a suitable material, such as thermoplastic. The pull bar 16 includes a cap 32 engaging the track 18. Unlike the conventional cap C in FIG. 2, the cap 32 has no sliding element. Rather, elimination of the sliding element makes room for the support arrangement 24, and the functions previously performed by the sliding element are assumed by the retention element 30.

The retraction mechanism 14 is provided with an end cap 34, as shown in FIG. 5. The end cap 5 is similar to that shown in FIG. 3. However, the end cap 34 includes a turning wedge 36 in a slot 38.

When the screen 12 is deployed, the retention element 30 is supported by the support arrangement 24, thus retaining the screen in the tracks 18, 20. The retention element 30 is rigid enough to be maintained in position between the longitudinal ledges 26, 28, but flexible enough to release from the longitudinal ledges 26, 28 given sufficient force. The size and material for the retention element can be chosen to provide any desired release force for safety purposes. For example, the force required to dislodge the retention element 30 can be chosen to be slightly below the force required to break through the screen 12. As the screen 12 is retracted, the turning wedge 36 deflects the retention element from a generally horizontal orientation as shown in FIG. 4 to a generally vertical orientation, thus facilitating winding of the retention element 30 around the retraction mechanism 14 along with the screen 12.

While details of the invention are discussed herein with reference to some specific examples to which the principles of the present invention can be applied, the applicability of the invention to other devices and equivalent components thereof will become readily apparent to those of skill in the art. Accordingly, it is intended that all such alternatives, modifications, permutations, and variations to the exemplary embodiments can be made without departing from the scope and spirit of the present invention.

What is claimed is:

1. A screen retention assembly for rolling screen systems covering an opening in a structure, the screen retention assembly comprising the following:
a retraction mechanism;
a pull bar;
a screen secured to the retraction mechanism and the pull bar;
at least one turning track spanning the opening; and
at least one flexible retention element connected to the screen, the retention element being secured in the at least one track.

2. A screen retention assembly in accordance with claim 1, wherein the at least one track comprises a support arrangement adapted and constructed to support the flexible retention mechanism within the turning track.

3. A screen retention assembly in accordance with claim 2, wherein the support arrangement includes at least one longitudinal ledge secured to the track.

4. A screen retention assembly in accordance with claim 3, wherein the at least one longitudinal ledge secured to the track comprises a pair of longitudinal ledges.

5. A screen retention assembly in accordance with claim 2, wherein the flexible track comprises a flexible strip secured to an edge of the screen.

5. A screen retention assembly in accordance with claim 2, wherein the flexible track comprises a flexible strip fabricated from a plastic material.

6. A screen retention assembly in accordance with claim 1, wherein the retraction mechanism comprises a housing having an end cap.

7. A screen retention assembly in accordance with claim 6, wherein the end cap comprises a turning wedge.
